(19) United States
(12) Patent Application Publication
(10) Pub. No.: US 2005/0152395 A1
(43) Pub. Date: Jul. 14, 2005

(54) Method and system for providing DHCP service in a multi-homed environment

(76) Inventor: Jeffery Arnold Hales, Suwanee, GA (US)

Correspondence Address: ARRIS INTERNATIONAL, INC, 3871 LAKEFIELD DRIVE, SUWANEE, GA, 30024, US

(21) Appl. No.: 11/034,461

(22) Filed: Jan. 13, 2005

Related U.S. Application Data
(60) Provisional application No. 60/536,051, filed on Jan. 13, 2004.

(51) Int. Cl. H04J 3/22; H04J 3/16; H04L 12/56; H04L 12/28; H04L 12/66

(52) U.S. Cl. 370/465; 370/401

(57) ABSTRACT

In a multi-unit building, a DHCP service receives a DHCP request from a user attempting to connect to the internet. A database associates a user's MAC address with an ISP identifier, and uses same to assign an available IP address from a pool of IP addresses that correspond to the ISP identifier. Databases that associate MAC addresses with ISPs, and a pool of IP addresses with each of the multiple ISPs, may reside on a DHCP server locally at the multi-unit building, or remote from the building at an ISP's local DHCP server. Thus, even if the building only has a single distribution network for providing broadband access, users at the building can choose access to the internet from among multiple ISPs having a contract with the building's management, rather than being stuck using only a single ISP that has a contract with the building's management.

### CROSS REFERENCE TO RELATED APPLICATION

This application claims priority under 35 U.S.C. 119(e) to Hales, U.S. provisional patent application No. 60/536,051 entitled “Unique method and system for providing DHCP service in a multi-homed environment”, which was filed Jan. 13, 2004, and is incorporated herein by reference in its entirety.

### FIELD OF THE INVENTION

The present invention relates generally to broadband communication networks, and more particularly to a method and system for providing multiple users in a multi-user environment broadband access to a choice of service providers' internetworks over an existing distribution network of the multi-user environment.

### BACKGROUND

As the availability of broadband access proliferates, more and more consumers are demanding access at their place of residence or temporary residence from numerous providers. Providers of broadband services, such as Multiple Service Operators (“MSO”), as they are known in the realm of cable television operators, have made laudable strides in the past few years to pass as many houses as possible. However, for consumers who do not own their residence, and therefore lease their residence, such as, for example, multi-unit dwellings, such as apartment buildings, hotels, townhouses, condominium, time shares, etc., the availability of broadband access is very limited and often problematic.

Although residents of these leased premises may use a dial-up modem with an active telephone access line, such service is not as desirable as data throughput is much less than with a broadband connection; and will not support many of the services offered today that require a high-speed broadband connection. To accommodate residents of these leased premises, landlords are beginning to offer broadband connection, or risk losing potential tenants to landlords that do. This broadband access may be provided to tenants using the coaxial cable network wiring that exists within a building or by providing ADSL service from the local telephone company, for example. With respect to the latter, the would-be subscriber is limited to whichever telephone company provides telephone service to the apartment building. Regarding the former, the same typically applies because either service is only available to the multi-unit dwelling from a single Internet service provider (“ISP”), or even if more than one provider is available at the premises, the building typically is only wired with television distribution and telephony distribution in mind. Thus, the building is usually only wired with one network for a given distribution type. Using existing technology to support multiple ISP access to tenants, a corresponding number of networks (wired and wireless) should exist within the apartment, hotel, time-share, etc.

Although this scenario may facilitate tenant subscribers having broadband access, each tenant is restricted to using whichever ISP the landlord has a contract with the provide service. Thus, if a subscriber who receives cable television and internet service from MSO 1 in Dallas, Tex., moves into an apartment in Chicago, Ill., wherein the apartment complex only offers broadband access via MSO 2, then the subscriber would have to cancel his or her subscription with MSO 1, along with relinquishing a well known email address and computer configuration, and have to establish a new subscription with MSO 2. In addition, if the subscriber in Dallas, Tex. is unhappy with the service offered by MSO 1 and wishes to move service elsewhere—it would not be possible.

Accordingly, there is a need for a method and system for facilitating the availability of multiple ISPs to multiple subscribers in a multi-unit dwelling without the need for adding additional wire networks within the build to support more than one provider.

Although this scenario may facilitate tenant subscribers having broadband access, each tenant is restricted to using whichever ISP the landlord has a contract with the provide service. Thus, if a subscriber who receives cable television and internet service from MSO 1 in Dallas, Tex., moves into an apartment in Chicago, Ill., wherein the apartment complex only offers broadband access via MSO 2, then the subscriber would have to cancel his or her subscription with MSO 1, along with relinquishing a well known email address and computer configuration, and have to establish a new subscription with MSO 2.

Accordingly, there is a need for a method and system for facilitating the availability of multiple ISPs to multiple subscribers in a multi-unit dwelling without the need for adding additional wire networks within the build to support more than one provider.

### SUMMARY

A multi-provider specialized Dynamic Host Configuration Protocol (“DHCP”) service works with one or more routers and switches to provide multiple subscribers within a multi-unit dwelling a choice of ISPs using an existing wire network that connects to each subscriber in the dwelling.

### BRIEF DESCRIPTION OF THE DRAWINGS

FIG. 1 illustrates a localized DHCP service in a multi-user, multi-ISP environment.

FIG. 2 illustrates a system having distributed DHCP servers in a multi-user, multi-ISP environment.

FIG. 3 illustrates a multi-user, multi-ISP system with a switched network architecture.

FIG. 4 Illustrates a method for providing localized DHCP service in a multi-user, multi-ISP environment.

FIG. 5 Illustrates a method for providing distributed DHCP service in a multi-user, multi-ISP environment.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

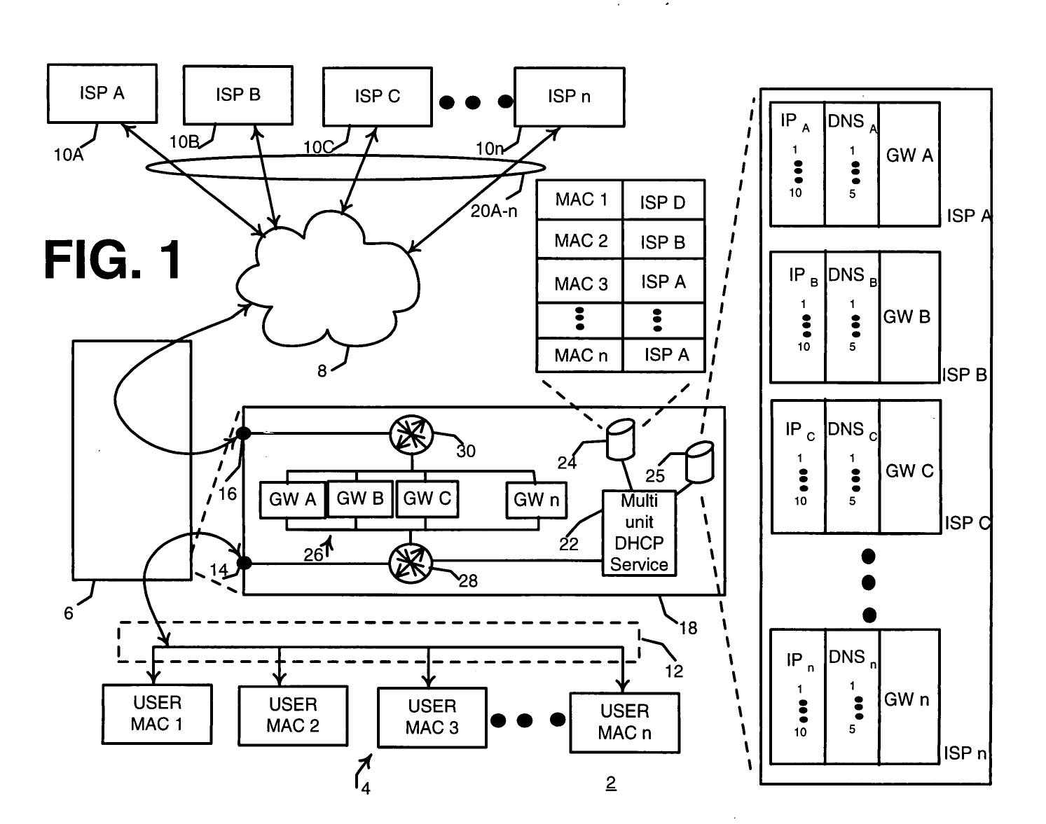

Turning now to the figures, FIG. 1 illustrates a system 2 for providing to users 4 that are tenants in a multi-unit environment 6, such as, for example, an apartment building, and office building, a hotel, etc., access to an internetwork 8 via multiple internet service providers (“ISP”) 10. In a typical existing multi-tenant environment 6, there is typically one distribution network 12 for a given type of signal. For example, for providing telephone service to each unit, or room, with in the building 6, conventional twisted-pair cabling may be used to connect to a central distribution block, typically located in the basement, or other centrally located, convenient for area for physical connections to each of the units to terminate. In addition to telephone wiring networks in multi-unit buildings 6, cable television is also typically connected to each room or unit with a single distribution network 12. However, whereas a telephone distribution network typically comprises separate cables, or at least wire pairs, that connect back to the central location, cable television distribution networks may comprise a single cable leading from the central location that then branch out at a splitter to feed either tenant units or other splitters. Thus, when distribution network 12 is a coaxial network within building 6 that distributes CATV signals to units throughout building 6, there is typically a single central location connection point 14 that provides a downstream signal to users and receives upstream signals from users. In addition to single distribution connection point 14, there may typically be a single internetwork connection point 16 that connects to network 8. Thus, a single Internet Service Provider (“ISP”) typically provides access to network 8 to all of the users 4.

To facilitate each user 4 connecting to network 8 using the ISP of their choice, connection manager 18 provides a means for interfacing with a plurality of internetwork access paths 20A-n corresponding to each of the plurality of service providers 10A-n. Connection manager 18 includes a multi-unit DHCP server 22 that assigns an IP address to a user device that is requesting a connection to internetwork 8. Server 22 assigns an IP address to a connection-requesting user 4 based on the ISP 10 with which the user has a subscription. Server 22 checks a unique identifier—such as, for example, a MAC address of the network interface card, DSL modem or cable modem, for example, connected to the user's personal computer (“PC”)—of the requesting user 4 contained in the requesting message packet, and determines a corresponding IP address to assign.

The IP address is assigned by server 22 from a pool of IP addresses associated with the user's 4 preferred ISP 10. The user's 4 unique identifier is used to perform a lookup of table 24, which associates the user's identifier with the user's preferred ISP 10. In the example illustrated in the figure, user 1 is associated with ISP D, user 2 with ISP B and user 3 and user n are associated with ISP A. When the ISP 10 that is preferred, or subscribed to, by the requesting user 4, server 22 uses this preferred ISP information to perform a query of table 25, which contains a pool of addresses for each ISP.

Thus, in the figure, the pools for ISPs A, B, C and n are represented by the blocks labeled ISP A, ISP B, ISP C and ISP n, respectively. Each block is divided into three portions. Each portion typically contains IP addresses. The portion labeled IP contains a pool of IP addresses that are allocated for use by users 4 that subscribe to the corresponding ISP 10. For example, the user 4 having identifier MAC 3, could potentially be assigned an IP address from the pool of IP addresses contained in the portion IPA of the ISP A block of table 25. Depending on how many other users 4 are accessing internetwork 8 from building 6 using ISP A when MAC 3 sends a connection request, the number of available IP addresses from the pool may be less than the total amount allocated to the pool. For example, the total number of IP addresses that ISP A has allocated to the pool shown in table 25 is ten. If the user 4 having identifier MAC n is already connected when the user having MAC 3 requests connection, then the total number of available IP addresses that can be assigned to MAC 3 is only nine. This process may continue until the IP addresses are all assigned. In the example, if ten users 4 who subscribe to ISP A are connected when an eleventh user who also subscribes to ISP A requests connection, the eleventh user will not be assigned an address, and will be unable to connect until an IP address is returned to the pool. It will be appreciated that multiple methods for tracking used IP addresses is known in the art.

In addition to the IP addresses contain in the IP portion, each ISP may include in its associated pool the IP addresses of multiple DNS servers that can be used for name resolution by an ISPs subscribers connecting at building 6. Also, the IP address of the gateway 26 that a given ISP's subscriber's packet traffic flows through may be specified in table 25.

Accordingly, even though the multi-unit building 6 may only have a single coaxial, DSL, DBS or other internetwork connection point 16 to internetwork 8, multi-unit DHCP server 22 can use tables 24 and 25 to determine an appropriate IP address selected from a range of subnet addresses so that a requesting user can connect to the internetwork through the single internetworking connection point. Depending on the number of users 4 that subscribe to a given ISP 10, more than one gateway 26 may be used to connect these users to internetwork connection point 16.

Therefore, when server 22 receives a DHCP request message, the identifier of the requesting device is located within database 24. The record that corresponds to the requesting device's identifier (typically MAC address) is used to determine the associated user's ISP. This ISP information contained in this record is then used to query table 25 to determine an IP address from available (currently unused addresses in the pool of a given ISP) IP addresses, DNS server address and address of the gateway 26 that corresponds to the ISP associated with the requesting user 4.

Regardless of the number of gateways corresponding to a given ISP, router 28 routes traffic between users 4, server 22 and gateways 26. Similarly, router 30 routes traffic between gateways 26 and internetwork 8. System 2 may be referred to as providing localized DHCP service because server and database 24 reside locally with respect to the multi-user environment 6. Routers 28 and 30 are examples of interfacing means that provide an interface between server 22, gateways 26, distribution network 12 and a plurality of internetwork access paths to internetwork 8. An access path may include a physical connection to an ISP 10, or a connection over which traffic is virtually routed according to IP addresses, or other device identifiers.

Variations with respect to the localized DHCP embodiment shown in FIG. 1 may also be implemented. In system 2 of FIG. 1, a pool, or subnet, of available IP addresses are stored in database 25. As discussed above, a given pool corresponds to a given ISP 10. Thus, for any given ISP, a certain number of IP addresses are reserved for use by users 4, who are located in multi-user environment 6. If for example 20 unique IP addresses are reserved for users 4 who are subscribers of ISP B, then other subscribers of ISP B, who are not located at building 6, cannot be assigned one of these reserved IP addresses.

Another aspect is that a separate dedicated pool of default IP address within table 25 may be established that are not associated with a particular ISP. Thus, if a new user, who is not currently subscribed to any ISP, attempts to access network 8, a default application operated by server 22 can assign a trial IP address from one of the available addresses in the default pool. Unregistered users 4 can then be directed to a web page that allows the user to signup for the ISP of his or her choice using the trial IP address. In addition, these trial IP addresses may be assigned to a user who already subscribes to an ISP that provides service to building 6, but for which all allocated IP addresses are currently assigned to other users. These users can be directed to a web pages with current network status information and an explanation of why they can not get on their selected ISP network.

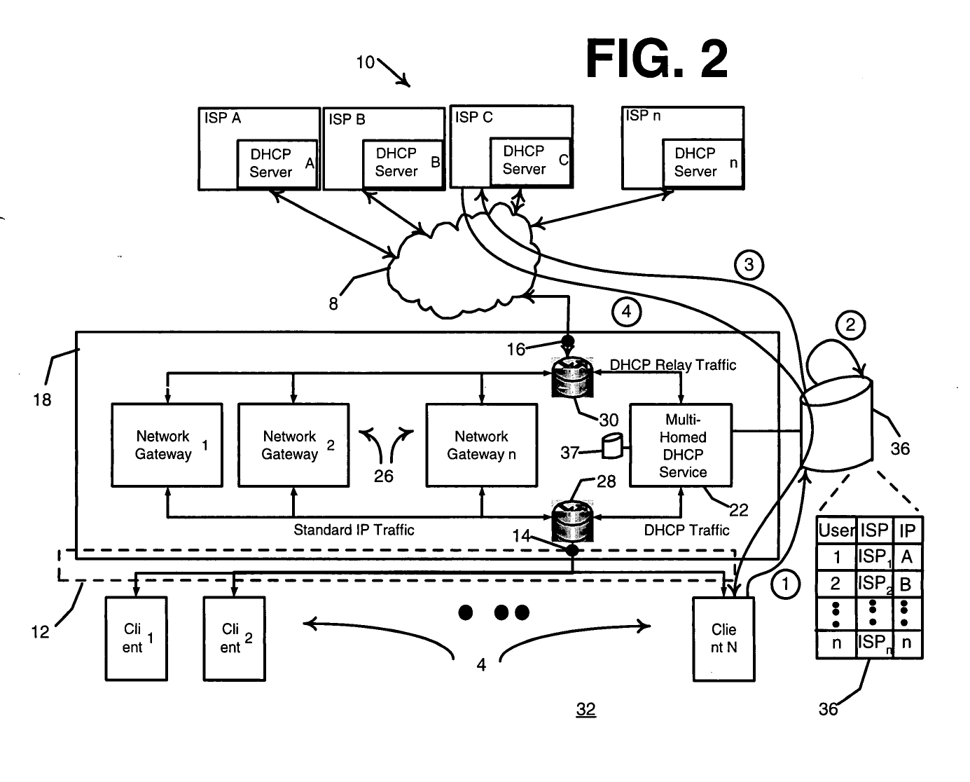

Turning now to FIG. 2, a distributed DHCP (relay) embodiment is shown. In this embodiment, distributed DHCP system 32 is similar to the embodiment shown in FIG. 1, inasmuch as server 22 receives a connection request from a client/user 4, and determines, based on a unique identifier, of the requesting device, the ISP to which the user subscribes. However, instead of retaining a pool of IP addresses corresponding to a given ISP at server 22, table 36 associates a user with that user's ISP and that ISP's IP address. Thus, in the example illustrated in the figure, users 4 are associated with ISPs as follows: user 1 subscribes to ISP B, user 2 subscribes to ISP A and user n subscribers to ISP C (which is not shown but implied by the ellipses between ISP B and ISP n). To illustrate the process in which this embodiment facilitates any user 4 obtaining connectivity to internetwork 8, client n sends a request message (typically a Discover command known in the art) to server 22 at encircled step 1. At encircled step 2, table 36 is queried to determine the ISP to which user n subscribes. The result, as discussed above, is that subscriber n subscribes to ISP C. Accordingly, the IP address associated ISP C is used to forward at encircled step 3 a connection request message to IP address C, which of course is the IP address of ISP C. The DHCP server at ISP C determines an available IP address, and sends it in a return message to user n at encircled step 4 via 16 and 22. Along with this IP address may be sent a DNS server address and an address for which gateway 26 to use. Alternatively, a table 37 at the server 22 may associate an ISP, based on its subnet, for example, with a particular gateway 26 and DNS server. Thus, server 22 and table 36 (and perhaps table 37) are used to determine the ISP to which a user subscribes and connects over distribution network 12. Using this information, a user's 4 DHCP request message is sent to the user's associated ISP via router 28 and multi-home server 22; where server 22 relays the DHCP request to the appropriate ISP's 10 DHCP server; the ISP's DHCP server responds with an offer to the user, via router 30 and server 22.

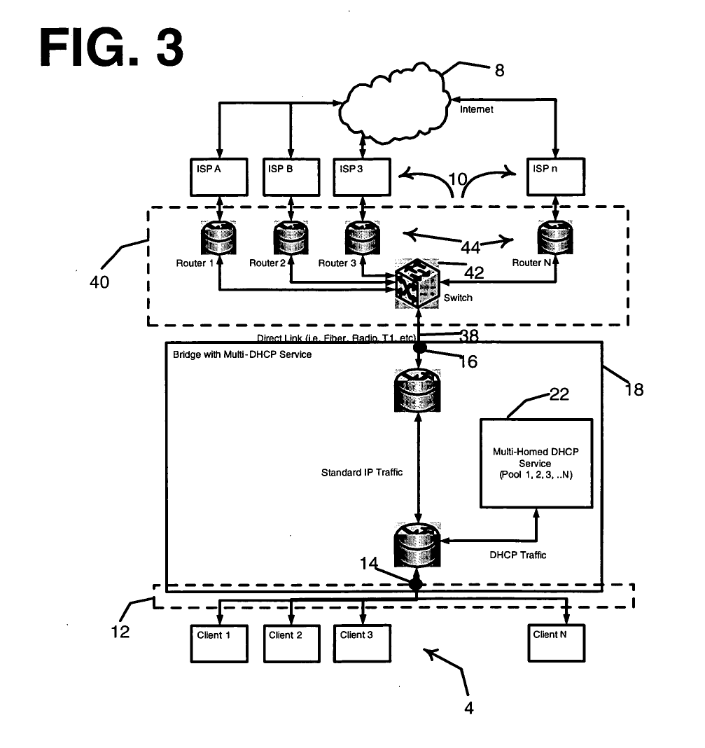

Turning now to FIG. 3, another alternative embodiment that may be used in a switched environment is shown. As in the previously discussed figures, multiple users 4 may obtain access to internetwork 8 through an ISP of their choice, even though the building in which the live or work uses a single distribution network 12. However, instead of connecting from internetwork connection point 16, as shown in FIG. 1, through internetwork 8 to ISPs for full access to the internetwork, a different network connection topology may be used. From internetwork connection point 16, a fiber 38, or other similar means, may connect to a central interface network 40. Network 40 may include a switch and multiple ISP routers 44, such that at least one ISP router exists for each ISP 10 that offers service to subscribers 4.

When a user device 4 requests a connection to internetwork 8, the ISP 10 that is associated with the requesting user 4 is determined by server 22 as discussed above. For example, server 22 may assign an IP address from among a pool of IP addresses that are associated with the ISP 10 to which a user 4 subscribes. A portion of this assigned IP address, such as, for example, a subnet mask corresponding to the IP address, may be used by switch 42 and routers 44 to establish connectivity between the requesting user and internetwork 8. Such an embodiment may facilitate higher bandwidth speeds for users 4 that are simultaneously connected to internetwork 8. In addition, the convergence of multiple types of Internet service providers, i.e., DSL, cable modem termination system (“CMTS”) and ISDN, for example, can transparently connect users 4 to internetwork 8. This transparent connectivity is facilitated regardless of the type of ISP or regardless of the ISP from among multiple ISPs of similar type to which a user subscribes, because switch 42 can determine router 44 to direct traffic based on a portion of the IP address assigned to a user sending a message toward internetwork 8. In this switched environment, gateways are located at a remote location, and provide connectivity over a shared backhaul connection at the property to a secondary service facility or location containing the gateways. This provides the advantage of reducing the equipment cost at multi-unit property and allows remote equipment in the secondary service facility to be shared, thereby reducing overall system cost when more than one multi-unit property is served by the same internetwork interface means. Another embodiment of the switched architecture combines providing DHCP server operations at the ISP location as shown in reference to FIG. 2.

In the figures discussed thus far, each embodiment illustrates a means for associating internetwork traffic on distribution network 12 associated with one or more of a plurality of users 4 with one of a plurality of internetwork access paths, wherein said associating means is coupled to the distribution network and to the interfacing means at a distribution connection point and an internetwork connection point respectively. In FIGS. 1 and 2, the interfacing means for interfacing the associating means 18 to the internetwork typically is router 30, as the physical internetwork connection point is at router 30. However, in FIG. 3, network 40 is the interfacing means for connecting the associating means 18 to the internetwork 8. Further, it will also be appreciated that in the figures, although routers 28 and 30 are shown schematically encompassed by the block diagram outline of associating means 18, routers 28 and 30 may also be separate devices from the associating means. In addition, routers 28 and 30, either separately or together, along with gateways 26 shown in FIGS. 1 and 2, may compose the means for interfacing with a plurality of internetwork access paths corresponding to each of the plurality of service providers 10, with server 22 and database 24 composing the associating means 18.

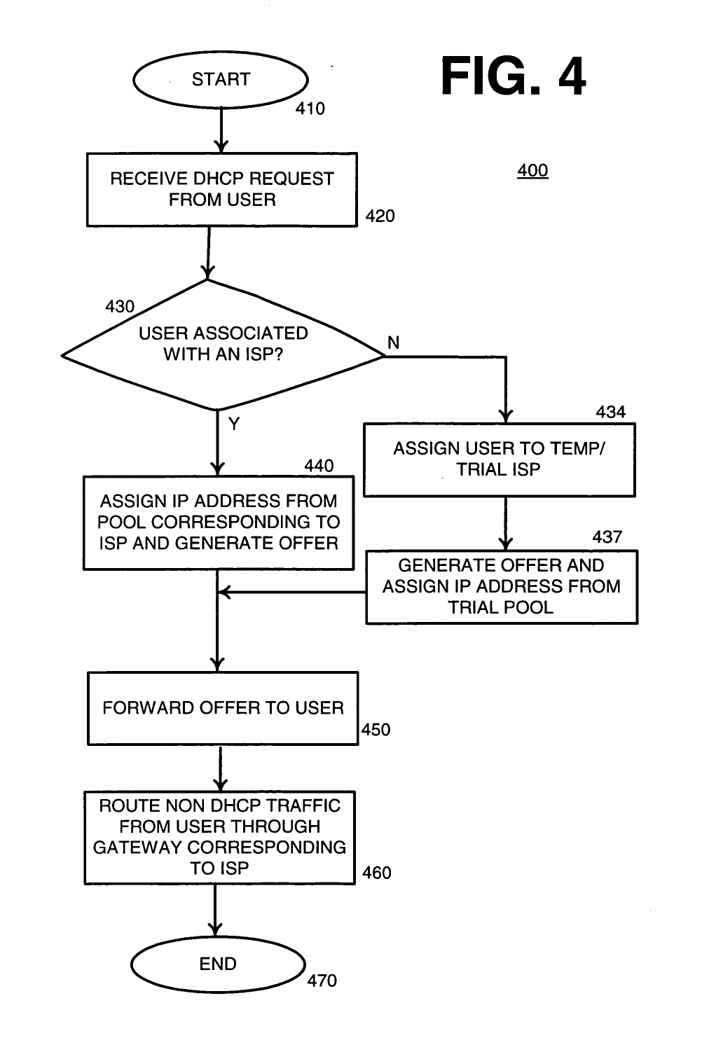

Turning now to FIG. 4, a method 400 is illustrated for providing to each of a plurality of users over a distribution network in a multi-user environment a choice from among a plurality of service providers to provide access to an internetwork using a local DHCP server arrangement. Method 400 starts at step 410 and a DHCP request from a user is received at step 420 by a multi-unit DHCP service, such as may be operative at server 22 described in connection with FIGS. 1-3. At step 430, the DHCP service determines whether the user is associated with a valid ISP that has contracted to provide services to users at the multi-unit building by querying a table or database indexed by unique user identifiers, such as MAC address of the requesting device, said table being configured to associated an ISP with every unique user identifier. If the user's identifier is located, a table/database that contains a pool of IP addresses that is associated with each associated ISP is queried to determine a currently unassigned IP address, and unassigned IP address encountered corresponding to the ISP determined at step 430 is assigned to the requesting user device at step 440 and an offer is generated.

If at step 430 it is determined that the requesting user is not associated with a valid ISP, the DHCP request may be assigned an IP address from among a pool of unused temporary, or ‘trial’, IP addresses and an offer generated at step 437. The trial IP address may be used to access any one of the valid ISPs, so that the user may subscribe to services with one of them.

Once an offer has been generated, it is forwarded to the user at step 450. When the offer is accepted by the user device, connections can be established and further non-DHCP traffic routed at step 460 through a local gateway corresponding to the ISP pool from which the IP address was assigned. The process ends at step 470.

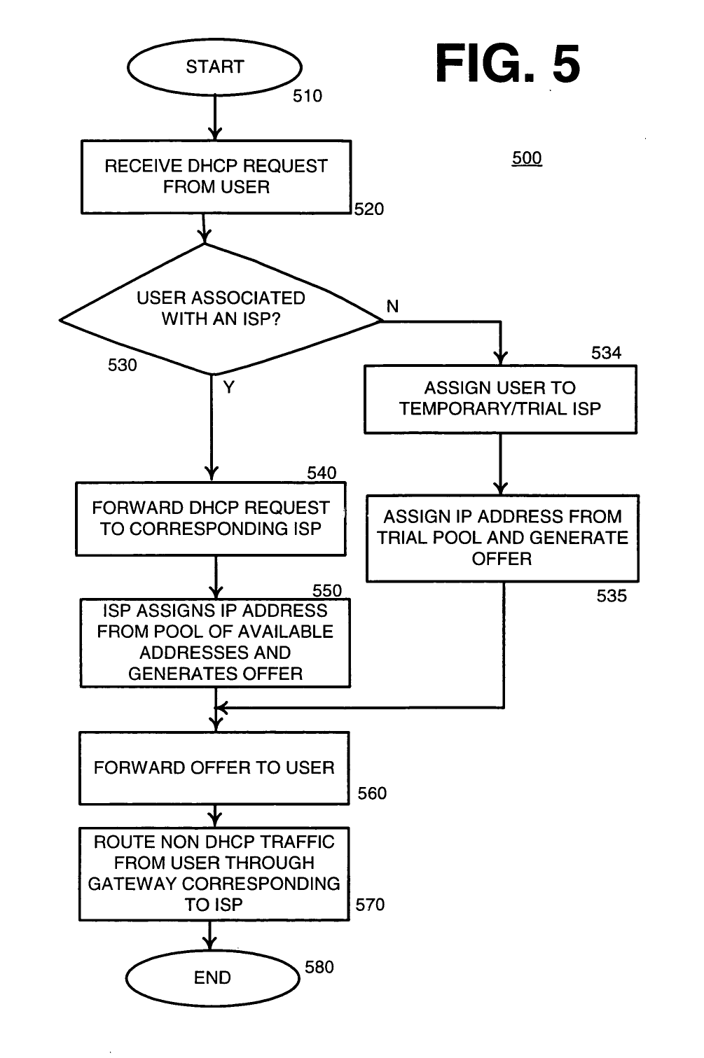

Turning now to FIG. 5, a flow diagram illustrates a method 500 for providing to each of a plurality of users over a distribution network in a multi-user environment a choice from among a plurality of service providers to provide access to an internetwork using a distributed DHCP server arrangement. The process 500 begins at step 510. When a DHCP request (Discover command) is received at step 520, a local DHCP service determines at step 530 whether the requesting user's device is associated with a valid ISP having a contract to provide services to users at the multi-unit location. If not, the user is assigned to a default or trial/temporary ISP pool at step 534, and an IP address is assigned and an offer generated at step 535. If assigned a temporary IP address a user 4 could be routed to a special web site allowing them to selecting from among the multiple providers the ISP available from which they can subscribe.

If the user was previously registered with a valid ISP, the DHCP request is now forwarded at step 540 to the ISP's DHCP server's IP address that has been assigned. When the DHCP request arrives at the corresponding ISP, a DHCP server at the ISP assigns an IP address to the user from among a pool of available IP addresses at step 550. The ISP DHCP server then generates an offer using this IP address and forwards same to the user at step 560. Further non-DHCP packet traffic between the ISP and user is routed at step 570 through a local gateway corresponding to the ISP. The process ends at step 580.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A system for providing to each of a plurality of users over a distribution network in a multi-user environment a choice from among a plurality of service providers that provide access to an internetwork, comprising:
means for interfacing with a plurality of internetwork access paths, each path corresponding to one of the plurality of service providers; and
means for associating internetwork traffic on the distribution network of each of the plurality of users with one of the plurality of internetwork access paths, wherein said associating means is coupled to the distribution network and to the interfacing means.

2. The system of claim 1 wherein the means for associating internetwork traffic with one of the plurality of internetwork access paths includes a means for storing and associating a service provider identifier with a unique identifier corresponding to each of a plurality of user devices.

3. The system of claim 2 wherein the means for associating internetwork traffic with one of the plurality of internetwork access paths includes a means for associating each of the plurality of users with one of the service providers.

4. The system of claim 2 wherein the means for associating internetwork traffic with one of the plurality of internetwork access paths includes means for assigning to a user device one of the network device identifiers corresponding to a service provider according to the service provider identifier associated with the user device.

5. The system of claim 2 wherein the network device identifiers associated with each one of the providers are Internet protocol addresses that compose a pool of Internet protocol addresses allocated to a service provider.

6. The system of claim 1 wherein the means for interfacing with a plurality of internetwork access paths includes:
a first router coupled to the internetwork; and
a plurality of gateways having at least one gateway corresponding to each of the plurality of internetwork access paths coupled to the first router.

7. The system of claim 1 wherein the means for interfacing with a plurality of internetwork access paths includes a central interface network, wherein each of said access paths includes a separate connection for the multi-user environment, the central interface network including:
a plurality of routers, wherein each of the plurality of routers is coupled to each of the connections; and
a means for passing traffic from the access paths based on an identifier associated with a service provider, wherein said passing means is coupled to each of the plurality of routers and the internetwork connection point.

8. The system of claim 7 wherein the passing means is a switch.

9. The system of claim 2 wherein the associating means includes a local DHCP server.

10. The system of claim 2 wherein the associating means includes a local DHCP service that communicates with a DHCP server of a service provider to determine which network device identifiers associated with each one of the plurality of service providers are available for assignment to a user.

11. The system of claim 5 wherein the means for associating internetwork traffic with one of the plurality of internetwork access paths includes a means for storing a plurality of network device trial identifiers to be used to establish a subscription with one of the plurality of service providers.

12. A method for providing to each of a plurality of users over a distribution network in a multi-user environment a choice from among a plurality of service providers that provide access to an internetwork, comprising:
receiving a DHCP request from a user;
associating the user with a service provider based on a unique identifier corresponding to the user;
assigning to the user a network device identifier from among a pool of network device identifiers that are associated with a service provider, said pool of network device identifiers being stored locally with respect to the distribution network;
establishing a connection between the user and the internetwork through the distribution network based on the assigned network device identifier.

13. The method of claim 12 wherein the unique identifier corresponding to the user is the Media Access Control address of the user's device that is requesting a connection to the internetwork.

14. The method of claim 12 wherein the network device identifier is an Internet Protocol address.

15. The method of claim 14 wherein the Internet Protocol address is assigned from a pool of available internet protocol addresses stored in an ISP address pool wherein a portion of each internet protocol address corresponds to a particular ISP.

16. The method of claim 15 wherein the Internet Protocol addresses associated with an ISP compose a subnet.

17. A method for providing to each of a plurality of users over a distribution network in a multi-user environment a choice from among a plurality of service providers that provide access to an internetwork, comprising:
receiving a DHCP request from a user;
associating the user with a service provider based on a unique identifier corresponding to the user;
forwarding the request to the service provider according to an network device identifier corresponding to the service provider; and
assigning to the user a network device identifier from among a pool of network device identifiers that are associated with a service provider, said pool of network device identifiers being stored locally with respect to the service provider.

18. The method of claim 17 wherein the unique identifier corresponding to the user is the Media Access Control address of the user's device that is requesting a connection to the internetwork.

19. The method of claim 17 wherein the network device identifier is an Internet Protocol address.

20. The method of claim 19 wherein the Internet Protocol address is assigned from a pool of available internet protocol addresses stored in an ISP address pool wherein a portion of each internet protocol address corresponds to a particular ISP.
